(19) United States
(12) Patent Application Publication
(10) Pub. No.: US 2019/0296815 A1
(43) Pub. Date: Sep. 26, 2019

(54) METHOD AND APPARATUS FOR HIGH CAPACITY ACCESS

(71) Applicant: Samsung Electronics Co., Ltd., Suwon-si (KR)

(72) Inventors: Eko Onggosanusi, Coppell, TX (US); Md Saifur Rahman, Plano, TX (US); Aris Papasakellariou, Houston, TX (US); Li Guo, Allen, TX (US)

(21) Appl. No.: 16/355,479

(22) Filed: Mar. 15, 2019

Related U.S. Application Data
(60) Provisional application No. 62/646,707, filed on Mar. 22, 2018.
(60) Provisional application No. 62/814,563, filed on Mar. 6, 2019.
(60) Provisional application No. 62/818,138, filed on Mar. 14, 2019.

(51) Int. Cl. H04B 7/06; H04B 7/0408; H04W 24/08; H04W 24/10; H04W 88/06; H04W 88/10; H04B 7/0456

(52) U.S. Cl. CPC H04B 7/0626; H04B 7/0408; H04B 7/0617; H04B 7/0456; H04W 24/10; H04W 88/06; H04W 88/10; H04W 24/08

(57) ABSTRACT

Methods and apparatuses for high capacity access. A method by a user equipment (UE) includes receiving, from a base station (BS), beam monitoring information, a downlink (DL) transmission assignment, and an associated DL transmission. The beam monitoring information includes a request for the UE to monitor and measure a quality of K beams. The method further includes decoding the beam monitoring information, the DL transmission assignment, and the associated DL transmission; and transmitting, to the BS, a beam metric report and a channel state information (CSI) report.

### CROSS-REFERENCE TO RELATED APPLICATIONS AND CLAIM OF PRIORITY

This application claims the priority to U.S. Provisional Patent Application Ser. No. 62/646,707 filed Mar. 22, 2018; U.S. Provisional Patent Application Ser. No. 62/814,563 filed Mar. 6, 2019; and U.S. Provisional Patent Application Ser. No. 62/818,138 filed Mar. 14, 2019. The above-identified provisional patent applications are hereby incorporated by reference in their entirety.

### TECHNICAL FIELD

The present disclosure relates generally to methods for wireless communication systems and, more specifically, to access, radio resource, and mobility procedures along with MIMO transmission.

### BACKGROUND

Wireless communication has been one of the most successful innovations in modern history. The demand of wireless data traffic is rapidly increasing due to the growing popularity among consumers and businesses of smart phones and other mobile data devices, such as tablets, “note pad” computers, net books, eBook readers, and machine type of devices. To meet the high growth in mobile data traffic and support new applications and deployments, improvements in radio interface efficiency and coverage is of paramount importance.

A mobile device or user equipment can measure the quality of the downlink channel and report this quality to a base station so that a determination can be made regarding whether or not various parameters should be adjusted during communication with the mobile device. Existing channel quality reporting processes in wireless communications systems do not sufficiently accommodate reporting of channel state information associated with large, two dimensional array transmit antennas or, in general, antenna array geometry which accommodates a large number of antenna elements.

### SUMMARY

Various embodiments of the present disclosure provide methods and apparatuses for CQI reporting.

In one embodiment, a user equipment (UE) is provided. The UE includes a transceiver and a processor operably connected to the transceiver. The transceiver is configured to receive, from a base station (BS), beam monitoring information, a downlink (DL) transmission assignment, and an associated DL transmission. The beam monitoring information includes a request for the UE to monitor and measure a quality of K beams. The processor is configured to decode the beam monitoring information, the DL transmission assignment, and the associated DL transmission. The transceiver is further configured to transmit, to the BS, a beam metric report and a channel state information (CSI) report.

In another embodiment, a BS is provided. The BS includes a processor and a transceiver operably connected to the processor. The processor is configured to generate beam monitoring information, a DL transmission assignment, and an associated DL transmission. The beam monitoring information includes a request for a UE to monitor and measure a quality of K beams. The transceiver is configured to transmit, to the UE, the beam monitoring information, the DL transmission assignment, and the associated DL transmission; and receive, from the UE, a beam metric report and a CSI report.

In yet another embodiment, a method for operating a UE is provided. The method includes receiving, from a BS, beam monitoring information, a DL transmission assignment, and an associated DL transmission. The beam monitoring information includes a request for the UE to monitor and measure a quality of K beams. The method further includes decoding the beam monitoring information, the DL transmission assignment, and the associated DL transmission; and transmitting, to the BS, a beam metric report and a CSI report.

The present disclosure relates to a pre-5th-Generation (5G) or 5G communication system to be provided for supporting higher data rates Beyond 4th-Generation (4G) communication system such as Long Term Evolution (LTE).

Other technical features may be readily apparent to one skilled in the art from the following figures, descriptions, and claims.

Before undertaking the DETAILED DESCRIPTION below, it can be advantageous to set forth definitions of certain words and phrases used throughout this disclosure. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller can be implemented in hardware or a combination of hardware and software and/or firmware. The functionality associated with any particular controller can be centralized or distributed, whether locally or remotely. The phrase “at least one of,” when used with a list of items, means that different combinations of one or more of the listed items can be used, and only one item in the list can be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this disclosure. Those of ordinary skill in the art should understand that in many, if not most, instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to various embodiments of the present disclosure;

FIGS. 2A and 2B illustrate example wireless transmit and receive paths according to various embodiments of the present disclosure;

FIG. 3A illustrates an example user equipment according to various embodiments of the present disclosure;

FIG. 3B illustrates an example BS according to various embodiments of the present disclosure;

FIG. 4 illustrates an example beamforming architecture wherein one CSI-RS port is mapped onto a large number of analog-controlled antenna elements;

FIG. 5 illustrates an example embodiment of a UE-centric access with two levels of radio resource entity according to an embodiment of the present disclosure;

FIG. 6 illustrates an example embodiment of beam-level access and mobility for DL transmission and reception according to an embodiment of the present disclosure;

FIG. 7 illustrates an example embodiment of UE procedure for DL beam monitoring and reception according to an embodiment of the present disclosure;

FIG. 8 illustrates another example embodiment of UE procedure for DL beam monitoring and reception according to an embodiment of the present disclosure;

FIG. 9 illustrates an example embodiment of beam-level access and mobility for UL transmission and reception according to an embodiment of the present disclosure;

FIG. 10 illustrates an example embodiment of UE procedure for UL beam monitoring and reception according to an embodiment of the present disclosure

FIG. 11 illustrates an example embodiment of L1 DL control signaling design according to an embodiment of the present disclosure

FIG. 12 illustrates a flowchart for an example method wherein a UE receives beam monitoring configuration according to an embodiment of the present disclosure; and

FIG. 13 illustrates a flowchart for an example method wherein a BS generates beam monitoring configuration for a UE (labeled as UE-k) according to an embodiment of the present disclosure.

### DETAILED DESCRIPTION

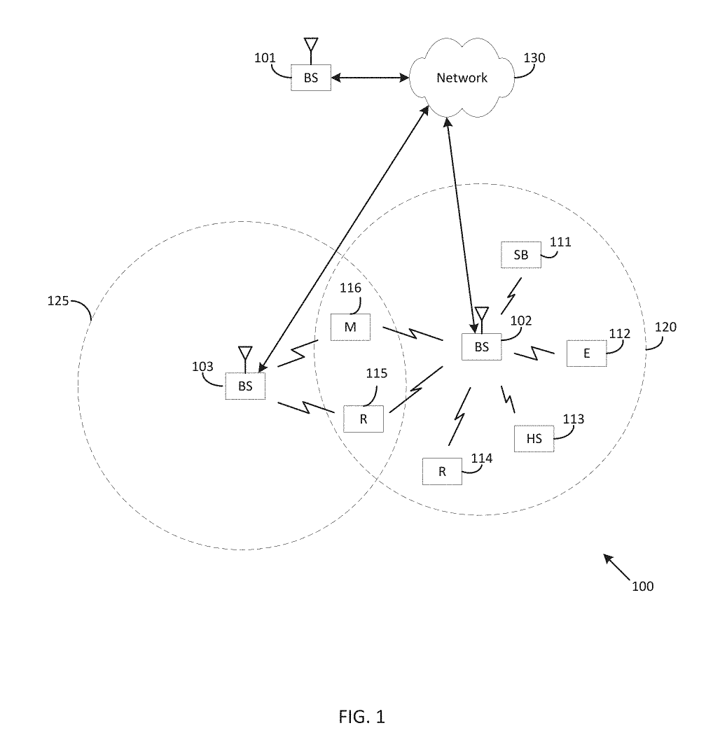

FIGS. 1 through 11, discussed below, and the various embodiments used to describe the principles of the present disclosure are by way of illustration only and should not be construed in any way to limit the scope of the disclosure. Those skilled in the art will understand that the principles of the present disclosure can be implemented in any suitably arranged wireless communication system.

### LIST OF ACRONYMS

2D: two-dimensional
MIMO: multiple-input multiple-output
SU-MIMO: single-user MIMO
MU-MIMO: multi-user MIMO
3GPP: 3rd generation partnership project
LTE: long-term evolution
UE: user equipment
eNB: evolved Node B or “eNB”
BS: base station
DL: downlink
UL: uplink
CRS: cell-specific reference signal(s)
DMRS: demodulation reference signal(s)
SRS: sounding reference signal(s)
UE-RS: UE-specific reference signal(s)
CSI-RS: channel state information reference signals
SCID: scrambling identity
MCS: modulation and coding scheme
RE: resource element
CQI: channel quality information
PMI: precoding matrix indicator
RI: rank indicator
MU-CQI: multi-user CQI
CSI: channel state information
CSI-IM: CSI interference measurement
CoMP: coordinated multi-point
DCI: downlink control information
UCI: uplink control information
PDSCH: physical downlink shared channel
PDCCH: physical downlink control channel
PUSCH: physical uplink shared channel
PUCCH: physical uplink control channel
PRB: physical resource block
RRC: radio resource control
AoA: angle of arrival
AoD: angle of departure

The following documents and standards descriptions are hereby incorporated by reference into the present disclosure as if fully set forth herein: 3GPP Technical Specification (TS) 36.211 version 12.4.0, “E-UTRA, Physical channels and modulation” (“REF 1”); 3GPP TS 36.212 version 12.3.0, “E-UTRA, Multiplexing and Channel coding” (“REF 2”); 3GPP TS 36.213 version 12.4.0, “E-UTRA, Physical Layer Procedures” (“REF 3”); 3GPP TS 36.321 version 12.4.0, “E-UTRA, Medium Access Control (MAC) Protocol Specification” (“REF 4”); 3GPP TS 36.331 version 12.4.0, “E-UTRA, Radio Resource Control (RRC) Protocol Specification” (“REF 5”); 3GPP Technical Specification (TS) 38.211 version 15.0.0, “NR, Physical channels and modulation” (“REF 6”); 3GPP TS 38.212 version 15.0.0, “NR, Multiplexing and Channel coding” (“REF 7”); 3GPP TS 38.213 version 15.0.0, “NR, Physical Layer Procedures for Control” (“REF 8”); 3GPP TS 38.214 version 15.0.0, “NR, Physical Layer Procedures for Data” (“REF 9”); 3GPP TS 38.321 version 15.0.0, “NR, Medium Access Control (MAC) Protocol Specification” (“REF 10”); 3GPP TS 38.331 version 15.0.0, “NR, Radio Resource Control (RRC) Protocol Specification” (“REF 11”); and 3GPP TS 38.215 version 15.0.0, “NR, Physical Layer Measurements” (“REF 12”)”.

To meet the demand for wireless data traffic having increased since deployment of 4G communication systems, efforts have been made to develop an improved 5G or pre-5G communication system. Therefore, the 5G or pre-5G communication system is also called a ‘Beyond 4G Network’ or a ‘Post LTE System’.

The 5G communication system is considered to be implemented in higher frequency (mmWave) bands, e.g., 60 GHz bands, so as to accomplish higher data rates. To decrease propagation loss of the radio waves and increase the transmission distance, the beamforming, massive multiple-input multiple-output (MIMO), Full Dimensional MIMO (FD-MIMO), array antenna, an analog beam forming, large scale antenna techniques are discussed in 5G communication systems.

In addition, in 5G communication systems, development for system network improvement is under way based on advanced small cells, cloud Radio Access Networks (RANs), ultra-dense networks, device-to-device (D2D) communication, wireless backhaul, moving network, cooperative communication, Coordinated Multi-Points (CoMP), reception-end interference cancellation and the like.

In the 5G system, Hybrid FSK and QAM Modulation (FQAM) and sliding window superposition coding (SWSC) as an advanced coding modulation (ACM), and filter bank multi carrier (FBMC), non-orthogonal multiple access (NOMA), and sparse code multiple access (SCMA) as an advanced access technology have been developed.

FIG. 1 illustrates an example wireless network 100 according to various embodiments of the present disclosure. The embodiment of the wireless network 100 shown in FIG. 1 is for illustration only. Other embodiments of the wireless network 100 can be used without departing from the scope of the present disclosure.

The wireless network 100 includes a base station (BS) 101, a BS 102, and a BS 103. The BS 101 communicates with the BS 102 and the BS 103. The BS 101 also communicates with at least one Internet Protocol (IP) network 130, such as the Internet, a proprietary IP network, or other data network. Instead of “BS”, an option term such as “eNB” (enhanced Node B) or “gNB” (general Node B) can also be used. Depending on the network type, other well-known terms can be used instead of “gNB” or “BS,” such as “base station” or “access point.” For the sake of convenience, the terms “gNB” and “BS” are used in the present disclosure to refer to network infrastructure components that provide wireless access to remote terminals. Also, depending on the network type, other well-known terms can be used instead of “user equipment” or “UE,” such as “mobile station,” “subscriber station,” “remote terminal,” “wireless terminal,” or “user device.” For the sake of convenience, the terms “user equipment” and “UE” are used in the present disclosure to refer to remote wireless equipment that wirelessly accesses an gNB, whether the UE is a mobile device (such as a mobile telephone or smartphone) or is normally considered a stationary device (such as a desktop computer or vending machine).

The gNB 102 provides wireless broadband access to the network 130 for a first plurality of user equipments (UEs) within a coverage area 120 of the gNB 102. The first plurality of UEs includes a UE 111, which can be located in a small business (SB); a UE 112, which can be located in an enterprise (E); a UE 113, which can be located in a WiFi hotspot (HS); a UE 114, which can be located in a first residence (R); a UE 115, which can be located in a second residence (R); and a UE 116, which can be a mobile device (M) like a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 can communicate with each other and with the UEs 111-116 using 5G, LTE, LTE-A, WiMAX, or other advanced wireless communication techniques.

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, can have other shapes, including irregular shapes, depending upon the configuration of the gNBs and variations in the radio environment associated with natural and man-made obstructions.

As described in more detail below, one or more of gNB 101, gNB 102, and gNB 103 transmit measurement reference signals to UEs 111-116 and configure UEs 111-116 for CSI reporting as described in embodiments of the present disclosure. In various embodiments, one or more of UEs 111-116 receive Channel State Information Reference Signal (CSI-RS) and transmit Sounding Reference Signal (SRS).

Although FIG. 1 illustrates one example of a wireless network 100, various changes can be made to FIG. 1. For example, the wireless network 100 can include any number of gNBs and any number of UEs in any suitable arrangement. Also, the gNB 101 can communicate directly with any number of UEs and provide those UEs with wireless broadband access to the network 130. Similarly, each gNB 102-103 can communicate directly with the network 130 and provide UEs with direct wireless broadband access to the network 130. Further, the gNB 101, 102, and/or 103 can provide access to other or additional external networks, such as external telephone networks or other types of data networks.

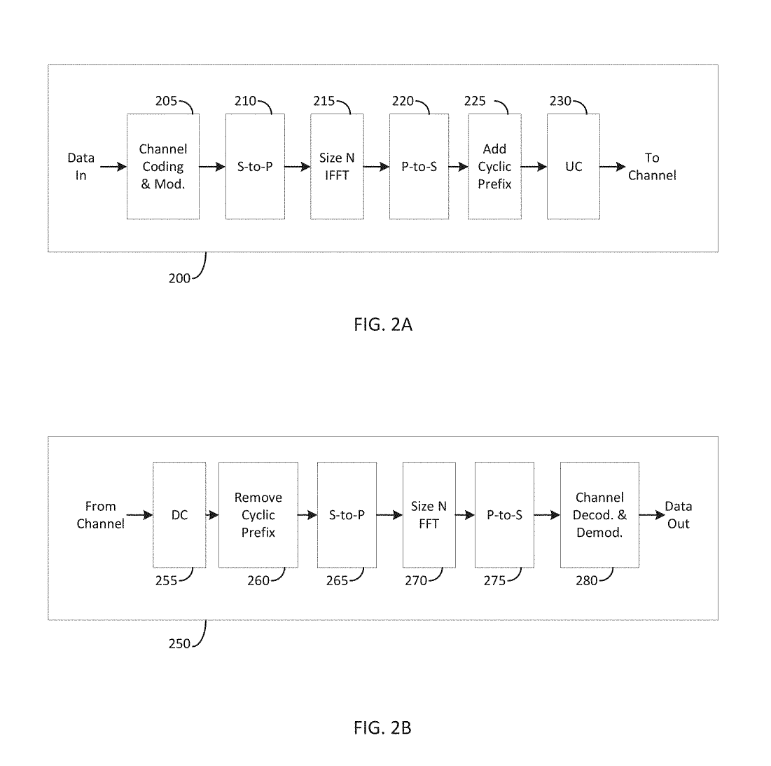

FIGS. 2A and 2B illustrate example wireless transmit and receive paths according to the present disclosure. In the following description, a transmit path 200 can be described as being implemented in a gNB (such as gNB 102), while a receive path 250 can be described as being implemented in a UE (such as UE 116). However, it will be understood that the receive path 250 can be implemented in a gNB and that the transmit path 200 can be implemented in a UE. In some embodiments, the receive path 250 is configured to receive CSI-RS and transmit SRS as described in embodiments of the present disclosure.

The transmit path 200 includes a channel coding and modulation block 205, a serial-to-parallel (S-to-P) block 210, a size N Inverse Fast Fourier Transform (IFFT) block 215, a parallel-to-serial (P-to-S) block 220, an ‘add cyclic prefix’ block 225, and an up-converter (UC) 230. The receive path 250 includes a down-converter (DC) 255, a ‘remove cyclic prefix’ block 260, a serial-to-parallel (S-to-P) block 265, a size N Fast Fourier Transform (FFT) block 270, a parallel-to-serial (P-to-S) block 275, and a channel decoding and demodulation block 280.

In the transmit path 200, the channel coding and modulation block 205 receives a set of information bits, applies coding (such as convolutional, Turbo, or low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The S-to-P block 210 converts (such as de-multiplexes) the serial modulated symbols to parallel data in order to generate N parallel symbol streams, where N is the IFFT/FFT size used in the gNB 102 and the UE 116. The size N IFFT block 215 performs an IFFT operation on the N parallel symbol streams to generate time-domain output signals. The P-to-S block 220 converts (such as multiplexes) the parallel time-domain output symbols from the size N IFFT block 215 in order to generate a serial time-domain signal. The ‘add cyclic prefix’ block 225 inserts a cyclic prefix to the time-domain signal. The UC 230 modulates (such as up-converts) the output of the ‘add cyclic prefix’ block 225 to an RF frequency for transmission via a wireless channel. The signal can also be filtered at baseband before conversion to the RF frequency.

A transmitted RF signal from the gNB 102 arrives at the UE 116 after passing through the wireless channel, and reverse operations to those at the gNB 102 are performed at the UE 116. The DC 255 down-converts the received signal to a baseband frequency, and the ‘remove cyclic prefix’ block 260 removes the cyclic prefix to generate a serial time-domain baseband signal. The serial-to-parallel block 265 converts the time-domain baseband signal to parallel time domain signals. The size N FFT block 270 performs an FFT algorithm to generate N parallel frequency-domain signals. The parallel-to-serial block 275 converts the parallel frequency-domain signals to a sequence of modulated data symbols. The channel decoding and demodulation block 280 demodulates and decodes the modulated symbols to recover the original input data stream.

As described in more detail below, the transmit path 200 or the receive path 250 can perform signaling for CSI reporting. Each of the gNBs 101-103 can implement a transmit path 200 that is analogous to transmitting in the downlink to UEs 111-116 and can implement a receive path 250 that is analogous to receiving in the uplink from UEs 111-116. Similarly, each of UEs 111-116 can implement a transmit path 200 for transmitting in the uplink to gNBs 101-103 and can implement a receive path 250 for receiving in the downlink from gNBs 101-103.

Each of the components in FIGS. 2A and 2B can be implemented using only hardware or using a combination of hardware and software/firmware. As a particular example, at least some of the components in FIGS. 2A and 2B can be implemented in software, while other components can be implemented by configurable hardware or a mixture of software and configurable hardware. For instance, the FFT block 270 and the IFFT block 215 can be implemented as configurable software algorithms, where the value of size N can be modified according to the implementation.

Furthermore, although described as using FFT and IFFT, this is by way of illustration only and should not be construed to limit the scope of the present disclosure. Other types of transforms, such as Discrete Fourier Transform (DFT) and Inverse Discrete Fourier Transform (IDFT) functions, can be used. It will be appreciated that the value of the variable N can be any integer number (such as 1, 2, 3, 4, or the like) for DFT and IDFT functions, while the value of the variable N can be any integer number that is a power of two (such as 1, 2, 4, 8, 16, or the like) for FFT and IFFT functions.

Although FIGS. 2A and 2B illustrate examples of wireless transmit and receive paths, various changes can be made to FIGS. 2A and 2B. For example, various components in FIGS. 2A and 2B can be combined, further subdivided, or omitted and additional components can be added according to particular needs. Also, FIGS. 2A and 2B are meant to illustrate examples of the types of transmit and receive paths that can be used in a wireless network. Other suitable architectures can be used to support wireless communications in a wireless network.

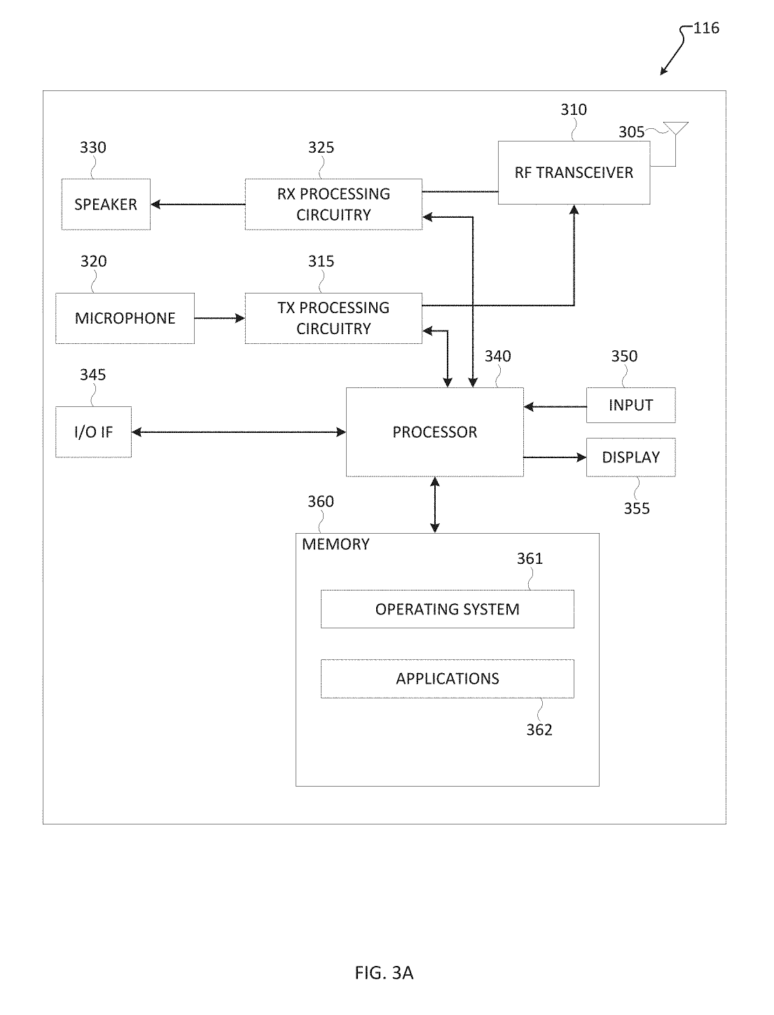

FIG. 3A illustrates an example UE 116 according to the present disclosure. The embodiment of the UE 116 illustrated in FIG. 3A is for illustration only, and the UEs 111-115 of FIG. 1 can have the same or similar configuration. However, UEs come in a wide variety of configurations, and FIG. 3A does not limit the scope of the present disclosure to any particular implementation of a UE.

The UE 116 includes an antenna 305, a radio frequency (RF) transceiver 310, transmit (TX) processing circuitry 315, a microphone 320, and receive (RX) processing circuitry 325. The UE 116 also includes a speaker 330, a processor 340, an input/output (I/O) interface 345, an input 350, a display 355, and a memory 360. The memory 360 includes an operating system (OS) program 361 and one or more applications 362.

The RF transceiver 310 receives, from the antenna 305, an incoming RF signal transmitted by a gNB of the wireless network 100 of FIG. 1. The RF transceiver 310 down-converts the incoming RF signal to generate an intermediate frequency (IF) or baseband signal. The IF or baseband signal is sent to the RX processing circuitry 325, which generates a processed baseband signal by filtering, decoding, and/or digitizing the baseband or IF signal. The RX processing circuitry 325 transmits the processed baseband signal to the speaker 330 (such as for voice data) or to the processor 340 for further processing (such as for web browsing data).

The TX processing circuitry 315 receives analog or digital voice data from the microphone 320 or other outgoing baseband data (such as web data, e-mail, or interactive video game data) from the processor 340. The TX processing circuitry 315 encodes, multiplexes, and/or digitizes the outgoing baseband data to generate a processed baseband or IF signal. The RF transceiver 310 receives the outgoing processed baseband or IF signal from the TX processing circuitry 315 and up-converts the baseband or IF signal to an RF signal that is transmitted via the antenna 305.

The processor 340 can include one or more processors or other processing devices and execute the OS program 361 stored in the memory 360 in order to control the overall operation of the UE 116. For example, processor 340 can control the reception of forward channel signals and the transmission of reverse channel signals by the RF transceiver 310, the RX processing circuitry 325, and the TX processing circuitry 315 in accordance with well-known principles. In some embodiments, the processor 340 includes at least one microprocessor or microcontroller.

The processor 340 is also capable of executing other processes and programs resident in the memory 360, such as operations for CSI-RS reception and measurement for systems described in embodiments of the present disclosure as described in embodiments of the present disclosure. The processor 340 can move data into or out of the memory 360 as required by an executing process. In some embodiments, the processor 340 is configured to execute the applications 362 based on the OS program 361 or in response to signals received from gNBs or an operator. The processor 340 is also coupled to the I/O interface 345, which provides the UE 116 with the ability to connect to other devices such as laptop computers and handheld computers. The I/O interface 345 is the communication path between these accessories and the processor 340.

The processor 340 is also coupled to the input 350 (e.g., keypad, touchscreen, button etc.) and the display 355. The operator of the UE 116 can use the input 350 to enter data into the UE 116. The display 355 can be a liquid crystal display or other display capable of rendering text and/or at least limited graphics, such as from web sites.

The memory 360 is coupled to the processor 340. The memory 360 can include at least one of a random access memory (RAM), Flash memory, or other read-only memory (ROM).

As described in more detail below, the UE 116 can perform signaling and calculation for CSI reporting. Although FIG. 3A illustrates one example of UE 116, various changes can be made to FIG. 3A. For example, various components in FIG. 3A can be combined, further subdivided, or omitted and additional components can be added according to particular needs. As a particular example, the processor 340 can be divided into multiple processors, such as one or more central processing units (CPUs) and one or more graphics processing units (GPUs). Also, while FIG. 3A illustrates the UE 116 configured as a mobile telephone or smartphone, UEs can be configured to operate as other types of mobile or stationary devices.

FIG. 3B illustrates an example gNB 102 according to the present disclosure. The embodiment of the gNB 102 shown in FIG. 3B is for illustration only, and other gNBs of FIG. 1 can have the same or similar configuration. However, gNBs come in a wide variety of configurations, and FIG. 3B does not limit the scope of the present disclosure to any particular implementation of a gNB. The gNB 101 and the gNB 103 can include the same or similar structure as the gNB 102.

As shown in FIG. 3B, the gNB 102 includes multiple antennas 370a-370n, multiple RF transceivers 372a-372n, transmit (TX) processing circuitry 374, and receive (RX) processing circuitry 376. In certain embodiments, one or more of the multiple antennas 370a-370n include 2D antenna arrays. The gNB 102 also includes a controller/processor 378, a memory 380, and a backhaul or network interface 382.

The RF transceivers 372a-372n receive, from the antennas 370a-370n, incoming RF signals, such as signals transmitted by UEs or other gNBs. The RF transceivers 372a-372n down-convert the incoming RF signals to generate IF or baseband signals. The IF or baseband signals are sent to the RX processing circuitry 376, which generates processed baseband signals by filtering, decoding, and/or digitizing the baseband or IF signals. The RX processing circuitry 376 transmits the processed baseband signals to the controller/processor 378 for further processing.

The TX processing circuitry 374 receives analog or digital data (such as voice data, web data, e-mail, or interactive video game data) from the controller/processor 378. The TX processing circuitry 374 encodes, multiplexes, and/or digitizes the outgoing baseband data to generate processed baseband or IF signals. The RF transceivers 372a-372n receive the outgoing processed baseband or IF signals from the TX processing circuitry 374 and up-converts the baseband or IF signals to RF signals that are transmitted via the antennas 370a-370n.

The controller/processor 378 can include one or more processors or other processing devices that control the overall operation of the gNB 102. For example, the controller/processor 378 can control the reception of forward channel signals and the transmission of reverse channel signals by the RF transceivers 372a-372n, the RX processing circuitry 376, and the TX processing circuitry 374 in accordance with well-known principles. The controller/processor 378 can support additional functions as well, such as more advanced wireless communication functions. In some embodiments, the controller/processor 378 includes at least one microprocessor or microcontroller.

The controller/processor 378 is also capable of executing programs and other processes resident in the memory 380, such as an OS. The controller/processor 378 is also capable of supporting channel quality measurement and reporting for systems having 2D antenna arrays as described in embodiments of the present disclosure. In some embodiments, the controller/processor 378 supports communications between entities, such as web RTC. The controller/processor 378 can move data into or out of the memory 380 as required by an executing process.

The controller/processor 378 is also coupled to the backhaul or network interface 382. The backhaul or network interface 382 allows the gNB 102 to communicate with other devices or systems over a backhaul connection or over a network. The backhaul or network interface 382 can support communications over any suitable wired or wireless connection(s). For example, when the gNB 102 is implemented as part of a cellular communication system (such as one supporting 5G or new radio access technology or NR, LTE, or LTE-A), the backhaul or network interface 382 can allow the gNB 102 to communicate with other gNBs over a wired or wireless backhaul connection. When the gNB 102 is implemented as an access point, the backhaul or network interface 382 can allow the gNB 102 to communicate over a wired or wireless local area network or over a wired or wireless connection to a larger network (such as the Internet). The backhaul or network interface 382 includes any suitable structure supporting communications over a wired or wireless connection, such as an Ethernet or RF transceiver.

The memory 380 is coupled to the controller/processor 378. The memory 380 can include at least one of a RAM, a Flash memory, or other ROM. In certain embodiments, a plurality of instructions, such as a BIS algorithm is stored in memory. The plurality of instructions are configured to cause the controller/processor 378 to perform the BIS process and to decode a received signal after subtracting out at least one interfering signal determined by the BIS algorithm.

As described in more detail below, the transmit and receive paths of the gNB 102 (implemented using the RF transceivers 372a-372n, TX processing circuitry 374, and/or RX processing circuitry 376) allocate and transmit CSI-RS as well as allocate and receive SRS.

Although FIG. 3B illustrates one example of a gNB 102, various changes can be made to FIG. 3B. For example, the gNB 102 can include any number of each component shown in FIG. 3A. As a particular example, an access point can include a number of backhaul or network interfaces 382, and the controller/processor 378 can support routing functions to route data between different network addresses. As another particular example, while shown as including a single instance of TX processing circuitry 374 and a single instance of RX processing circuitry 376, the gNB 102 can include multiple instances of each (such as one per RF transceiver).

Rel.13 LTE supports up to 16 CSI-RS antenna ports which enable a gNB to be equipped with a large number of antenna elements (such as 64 or 128). In this case, a plurality of antenna elements is mapped onto one CSI-RS port. Furthermore, up to 32 CSI-RS ports will be supported in Rel.14 LTE. For next generation cellular systems such as 5G, it is expected that the maximum number of CSI-RS ports remain more or less the same.

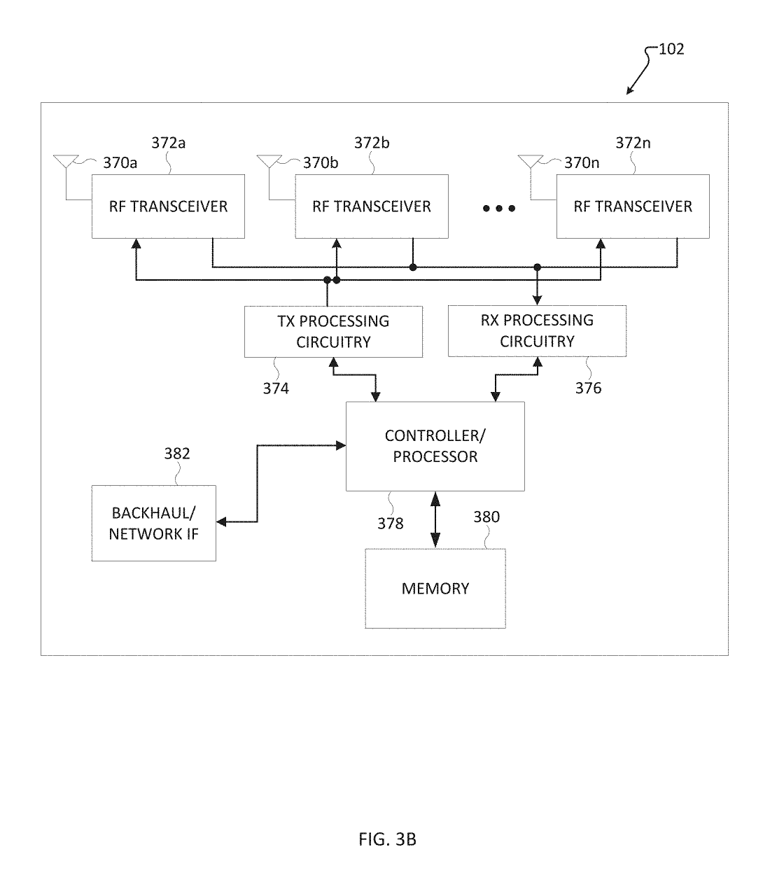

For mmWave bands, although the number of antenna elements can be larger for a given form factor, the number of CSI-RS ports—which can correspond to the number of digitally precoded ports—tends to be limited due to hardware constraints (such as the feasibility to install a large number of ADCs/DACs at mmWave frequencies) as illustrated in embodiment 400 of FIG. 4. In this case, one CSI-RS port is mapped onto a large number of antenna elements which can be controlled by a bank of analog phase shifters 401. One CSI-RS port can then correspond to one sub-array which produces a narrow analog beam through analog beamforming 405. This analog beam can be configured to sweep across a wider range of angles 420 by varying the phase shifter bank across symbols or subframes or slots (wherein a subframe or a slot comprises a collection of symbols and/or can comprise a transmission time interval). The number of sub-arrays (equal to the number of RF chains) is the same as the number of CSI-RS ports N_{CSI-PORT}. A digital beamforming unit 410 performs a linear combination across N_{CSI-PORT} analog beams to further increase precoding gain. While analog beams are wideband (hence not frequency-selective), digital precoding can be varied across frequency sub-bands or resource blocks.

To enable digital precoding, efficient design of CSI-RS is a crucial factor. For this reason, three types of CSI reporting mechanisms corresponding to three types of CSI-RS measurement behavior are supported in Rel.13/14 LTE: 1) ‘CLASS A’ CSI reporting which corresponds to non-precoded CSI-RS, 2) ‘CLASS B’ reporting with K=1 CSI-RS resource which corresponds to UE-specific beamformed CSI-RS, and 3) ‘CLASS B’ reporting with K>1 CSI-RS resources which corresponds to cell-specific beamformed CSI-RS. For non-precoded (NP) CSI-RS, a cell-specific one-to-one mapping between CSI-RS port and TXRU is utilized. Here, different CSI-RS ports have the same wide beam width and direction and hence generally cell wide coverage. For beamformed CSI-RS, beamforming operation, either cell-specific or UE-specific, is applied on a non-zero-power (NZP) CSI-RS resource (including multiple ports). Here, (at least at a given time/frequency) CSI-RS ports have narrow beam widths and hence not cell wide coverage, and (at least from the eNB perspective) at least some CSI-RS port-resource combinations have different beam directions. In 5G NR, such differentiation is not supported although the CSI acquisition framework is designed to accommodate such use cases.

In 3GPP LTE and NR (new radio access or interface), network access and radio resource management (RRM) are enabled by physical layer synchronization signals and higher (MAC) layer procedures. In particular, a UE attempts to detect the presence of synchronization signals along with at least one cell ID for initial access. Once the UE is in the network and associated with a serving cell, the UE monitors several neighboring cells by attempting to detect their synchronization signals and/or measuring the associated cell-specific RSs (for instance, by measuring their RSRPs). For next generation cellular systems, efficient and unified radio resource acquisition or tracking mechanism which works for various use cases (such as eMBB, URLLC, mMTC, each corresponding to a different coverage requirement) and frequency bands (with different propagation losses) is desirable. For next generation cellular systems that may be designed with a different network and radio resource paradigm, seamless and low-latency RRM is also desirable. Such goals pose at least the following problems in designing an access, radio resource, and mobility management framework.

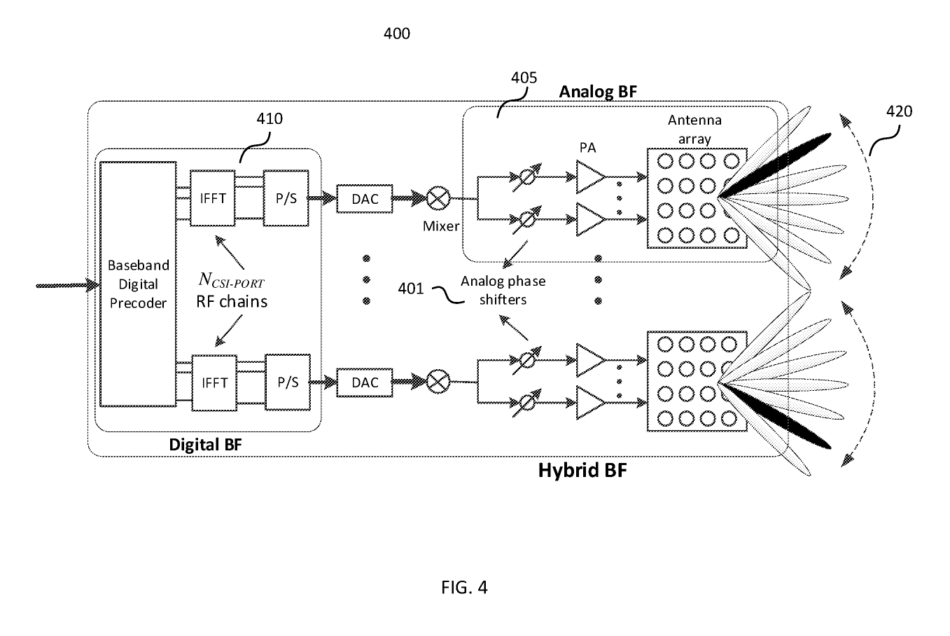

First, since NR is likely to support even more diversified network topology, the notion of a cell can be redefined or replaced with another radio resource entity. As an example, for synchronous networks, one cell can be associated with a plurality of TRPs (transmit-receive points) similar to a COMP (coordinated multipoint transmission) scenario in LTE. In this case, seamless mobility is a desirable feature. Second, when large antenna arrays and beamforming are utilized, defining radio resource in terms of beams (although possibly termed differently) can be a natural approach. Given that numerous beamforming architectures can be utilized, an access, radio resource, and mobility management framework which accommodates various beamforming architectures (or, instead, agnostic to beamforming architecture) is desirable. For instance, the framework can be applicable for or agnostic to whether one beam is formed for one CSI-RS port (for instance, where a plurality of analog ports are connected to one digital port, and a plurality of widely separated digital ports are utilized) or one beam is formed by a plurality of CSI-RS ports. In addition, the framework can be applicable whether beam sweeping (as illustrated in FIG. 5) is used or not. Third, different frequency bands and use cases impose different coverage limitations. For example, mmWave bands impose large propagation losses. Therefore, some form of coverage enhancement scheme is needed. Several candidates include beam sweeping (cf. FIG. 5), repetition, diversity, and/or multi-TRP transmission. For mMTC where transmission bandwidth is small, time-domain repetition is needed for sufficient coverage.

A prerequisite to seamless access is significant reduction of higher-layer procedures for UEs which are already connected to the network. For instance, the existence of cell boundaries (or in general the notion of cells) necessitates RRC (L3) reconfiguration as a UE moves from one cell to another (i.e. inter-cell mobility). For heterogeneous networks with closed subscriber groups, additional overhead associated with higher layer procedures may further tax the system. This can be achieved by relaxing the cell boundaries thereby creating a large “super-cell” wherein a large number of UEs can roam. In this case, high capacity MIMO transmission (especially MU-MIMO) becomes more prevalent. While this presents an opportunity to increase system capacity (measured in terms of the number of sustainable UEs), it uses a streamlined MIMO design. This poses a challenge if applied in the current system.

Therefore, there is a need for an access, radio resource, and mobility management framework which facilitates seamless access by reducing the amount of higher layer procedures. In addition, there is also a need for a streamlined MIMO design that facilitates high capacity MIMO transmission.

In the following, for brevity, both FDD and TDD are considered as the duplex method for both DL and UL signaling.

Although various descriptions and embodiments of the present disclosure assume orthogonal frequency division multiplexing (OFDM) or orthogonal frequency division multiple access (OFDMA), the embodiments presented in the present disclosure can be extended to other OFDM-based transmission waveforms or multiple access schemes such as filtered OFDM (F-OFDM).

The present disclosure includes the following components which can be used in conjunction or in combination with one another, or can operate as standalone schemes. A first component pertains to initial access and radio resource management. A second component pertains to DL MIMO configuration. A third component pertains to UL MIMO configuration. A fourth component pertains to DL control signaling.

Each of these components can be used either by itself (without the other component) or in conjunction with at least one of the other component. Likewise, each of these components includes a plurality of sub-components. Each of the sub-components can be used either by itself (without any other sub-component) or in conjunction with at least one of the other sub-components. For instance, any example embodiment of the fourth component (condition of usage of a UCI multiplexing scheme) can be combined with any example embodiment of the fifth component (UCI multiplexing scheme).

All the following components and embodiments are applicable for UL transmission with CP-OFDM (cyclic prefix OFDM) waveform as well as DFT-SOFDM (DFT-spread OFDM) and SC-FDMA (single-carrier FDMA) waveforms. Furthermore, all the following components and embodiments are applicable for UL transmission when the scheduling unit in time is either one subframe (which can include one or multiple slots) or one slot, wherein one subframe or slot can comprise a transmission time interval.

For the first component (that is, initial access and radio resource management), in one embodiment, a UE-centric access which utilizes two levels of radio resource entity is described in embodiment 500 of FIG. 5. These two levels can be termed as “cell” and “beam”. These two terms are used for illustrative purposes thereby serving as examples. Other terms such as radio resource (RR) 1 and 2 can also be used. Additionally, the term “beam” as a radio resource unit is to be differentiated with, for instance, an analog beam used for beam sweeping in FIG. 4. In place of “beam”, terms associated with spatial transmission such as “port”, “antenna port”, or “virtual antenna/port” can be used.

In terms of physical layer signals, the entity “beam” can be associated with one or two antenna ports, or one- or two-port non-zero-power (NZP) CSI-RS resource. Two ports are used, for instance, when dual-polarized antenna array is used at the transmitter. Other types of measurement RS can also be used, such as synchronization signal block (SSB) or demodulation RS (DMRS). If associated with an RS, the RS can provide a reference for measurement, precoding, and/or data transmission.

This embodiment is especially relevant for, although not limited to, synchronous network where cells within a network are synchronized in time and frequency within a certain range of values. Furthermore, this embodiment is especially relevant, although not limited to the case, when a TRP utilizes at least one antenna array which can be used for beamforming.

The first RR level (termed “cell”) applies when a UE enters a network and therefore is engaged in an initial access procedure. In embodiment 510, a UE 511 is connected to cell 512 after performing an initial access procedure which includes detecting the presence of synchronization signals. Synchronization signals can be used for coarse timing and frequency acquisitions as well as detecting the cell identification (cell ID) associated with the serving cell. In this first level, the UE observes cell boundaries as different cells can be associated with different cell IDs. In FIG. 5, one cell is associated with one TRP (in general, one cell can be associated with a plurality of TRPs). Since cell ID is a MAC layer entity, initial access involves not only physical layer procedure(s) (such as cell search via synchronization signal acquisition) but also MAC layer procedure(s).

The second RR level (termed “beam”) applies when a UE is already connected to a cell and hence in the network. In this second level, UE 511 can move within the network without observing cell boundaries as illustrated in embodiment 550. That is, UE mobility is handled on beam level rather than cell level, where one cell can be associated with N beams (N can be 1 or >1). Unlike cell, however, beam is a physical layer entity. Therefore, UE mobility management is handled solely on physical layer—hence using physical layer procedure(s) without MAC layer procedure(s).

An example of UE mobility scenario based on the second level RR is given in embodiment 550 of FIG. 5. After UE 511 is associated with the serving cell 512, UE 511 is further associated with beam 551. This is achieved by acquiring a beam or radio resource (RR) acquisition signal from which the UE can acquire a beam identity or identification. An example of beam or RR acquisition signal is a measurement reference signal (RS). Upon acquiring a beam (or RR) acquisition signal, UE 511 can report a status to the network or an associated TRP. Examples of such report include a measured beam power (or measurement RS power) or a set of at least one recommended beam identity. Based on this report, the network or the associated TRP can assign a beam (as a radio resource) to UE 511 for data and control transmission. When UE 511 moves to another cell, the boundary between the previous and the next cells is neither observed nor visible to UE 511. Instead of cell handover, UE 511 switches from beam 551 to beam 552. Such a seamless mobility is facilitated by the report from UE 511 to the network or associated TRP—especially when UE 511 reports a set of M>1 preferred beam identities by acquiring and measuring M beam (or RR) acquisition signals.

Therefore, synchronization signals are acquired only during initial access. Once a UE is connected to the network and associated with a cell, UE mobility is handled on beam level and cell boundaries are no longer observed—thereby attaining the so-called “one cell” or “boundary-less cell” network (from UE perspective). Hence, synchronization signals need no longer be acquired. Instead, beam (RR) acquisition signals (such as measurement RSs) are used for radio resource management (RRM). In other words, cell ID (a MAC layer entity, carried by synchronization signal(s)) is acquired only during initial access whereas “beam ID” (a physical layer entity, carried by beam (RR) acquisition signal such as a measurement RS) is acquired for mobility and/or RRM. Once the UE is in the network, the UE is not required to acquire or monitor cell ID(s) from synchronization signals. Either cell ID(s) become irrelevant for the UE or are signaled to the UE in association with an acquired beam ID.

This, of course, does not preclude some UE implementations which make use of synchronization signals, in addition to beam (RR) acquisition signals, to assist beam (RR) acquisition or tracking for UE mobility.

For certain scenarios such as asynchronous networks, a UE in radio link failure (RLF), connection loss, or Idle mode, the UE can fall back to cell ID based or cell-level mobility management similar to 3GPP LTE and NR. Therefore, only one of the two levels of radio resource entity (cell) is applicable. Such information, whether the UE assumes beam-level mobility (where cell boundaries are neither observed nor visible from UE perspective) or cell-level mobility (where cell boundaries are observed and visible from UE perspective), can be obtained once a UE is connected to the network. This can be signaled via a DL control signaling, whether on L1, MAC, and/or RRC level.

When a two-level (“cell” and “beam”) radio resource entity or management is utilized, synchronization signal(s) can be designed primarily for initial access into the network. For mmWave systems where analog beam sweeping (cf. FIG. 4) or repetition may be used for enhancing the coverage of common signals (such as synchronization signal(s) and broadcast channel), synchronization signals can be repeated across time (such as across OFDM symbols or slots or subframes). This repetition factor, however, is not necessarily correlated to the number of supported “beams” (defined as radio resource units, to be differentiated with the analog beams used in beam sweeping) per cell or per TRP. Therefore, beam identification (ID) is not acquired or detected from synchronization signal(s). Instead, beam ID is carried by a beam (RR) acquisition signal such as measurement RS. Likewise, beam (RR) acquisition signal does not carry cell ID (hence, cell ID is not detected from beam or RR acquisition signal).

For the second component (that is, DL MIMO configuration), with seamless mobility and boundary-less network (beam-level access without cell boundaries), the conventional cell-specific antenna port framework is no longer suitable. For conventional cellular networks, all the UEs connected to a cell share the antenna ports generated by at least one TRP for that cell. When cell boundaries are neither observed nor “visible” to the UEs (as illustrated in FIG. 5), every UE in the network can potentially share any spatial-domain transmission resource generated from any of the TRPs in the network. Therefore, the conventional measurement antenna port (usually associated with CSI-RS), a cell-specific entity, is no longer appropriate. And neither is “CSI-RS resource” (an abstraction for defining measurement resource characterized in spatial, time, and frequency domain). It is appropriate, however, to correlate this spatial-domain transmission resource with one antenna port, or one-port CSI-RS resource, or two antenna ports, or two-port CSI-RS resource. Two ports are used, for instance, when dual-polarized antenna array is used at the transmitter.

For this purpose, any control signaling required for configuration can be performed dynamically, either with L1 DL control signaling (via, e.g. PDCCH in NR) or L2 DL control signaling (via, e.g. MAC CE in NR). For seamless mobility and boundary-less network, reconfiguration via higher-layer (L3/RRC) signaling is either minimized or avoided.

Various other embodiments that are suited for beam-based access (wherein conventional cell boundaries are no longer utilized) are given below. The design below can be characterized as “flat” (as opposed to hierarchical).

One radio resource unit can be defined in terms of one spatial unit (termed “beam” for illustrative purposes) and one time-frequency unit (for example, symbol-sub-carrier, slot-sub-carrier, slot-frequency resource block, etc.).

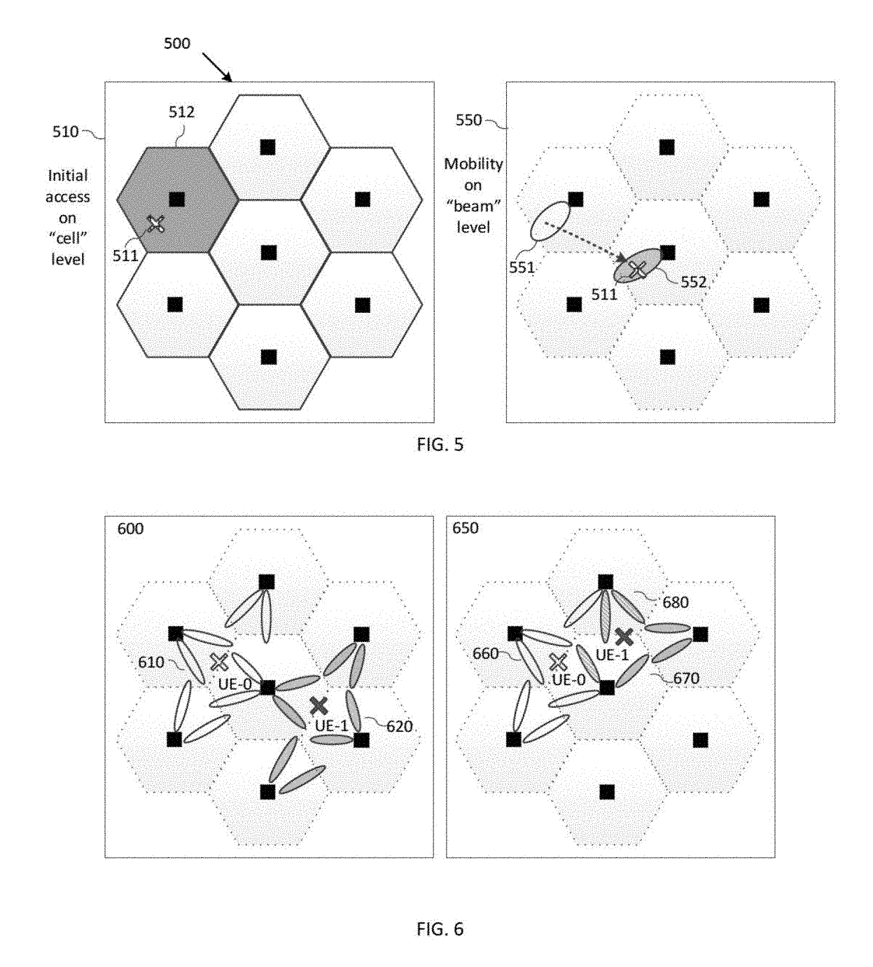

In one embodiment, illustrated in FIG. 6, a method for configuring DL MIMO can be described as follows. In this case, “beam” can be analogous to the conventional DL antenna port in terms of its function for MIMO-related transmission and measurement. Each beam can be associated with a CSI-RS which can span over one or multiple time-frequency units. In this setup, a UE connected to the network can be assigned to monitor or measure at least one beam. As the UE measures the channel quality via a reference signal (such as CSI-RS) associated with each of the beam(s), the UE can report CSI to the network. In turn, the network can perform scheduling and link adaptation to assign a DL transmission to the UE via the assigned beam(s) wherein some precoding for data transmission can be performed across the assigned beam(s). The beam assignment can be changed dynamically for the UE. Here, dynamic refers to the use of physical layer (L1) control signaling or at most MAC layer (L2) control signaling to effect the change in beam assignment. In addition, dynamic is to be contrasted with semi-static (wherein higher-layer/RRC/L3 signaling is used which can cause disruption in seamless access due to its associated latency) or static (unchanged).

This embodiment can be illustrated in FIG. 6. In diagram 600, each of the two UEs (UE-0 and UE-1) is assigned to monitor a set of Kₖ=8 beams (610 for UE-0 and 620 for UE-1). The two 8-beam sets do not overlap. As UE-k (k=0 or 1) moves, the beam assignment (which can include the set of beams and/or the number of beams in the assigned set) can change. The change of beam assignment can be signaled to UE-k via L1 or L2 DL control signaling (for NR, it is PDCCH or MAC CE). If L1 control signaling is used, this beam assignment signaling can be included in a UE-specific downlink control information (DCI) or a UE-group DCI—masked or identified with a UE identification (such as C-RNTI) or a special group RNTI, respectively. The value of Kₖ can be configured/assigned by the network (dynamically, signaled via L1/L2 DL control signaling).

If the two 8-beam sets in diagram 600 are non-overlapping, diagram 650 illustrates another example wherein K₀=8 and K₁=6 and, in addition, 3 of the beams assigned to the two UEs are shared (680). From the perspective of UE-0 3 out of 8 beams are shared with UE-1 and 5 are configured only to UE-0 (660). Likewise, from the perspective of UE-1 3 out of 6 beams are shared with UE-0 and 3 are configured only to UE-0 (670). Note that the setup can change from 600 to 650 as UE-1 moves from one geographical location to another.

To illustrate further, each of the UEs in diagram 600 monitors the 8 assigned beams by measuring 8 beam-specific RS associated with those 8 beams. This measurement is then used to calculate beam-specific metrics such as L1-RSRP or CSI (which can include RI, PMI, and/or CQI) which can be accompanied with at least one beam index (BI). In NR, BI is represented by CRI (CSI-RS resource index). If the entity of “CSI-RS resource” is not used, a different nomenclature which refers to either the “beam” or the corresponding RS is used. UE-k can report this measurement to the network for the purpose of link adaptation and scheduling.

Several sub-embodiments on beam metric reporting are as follows.

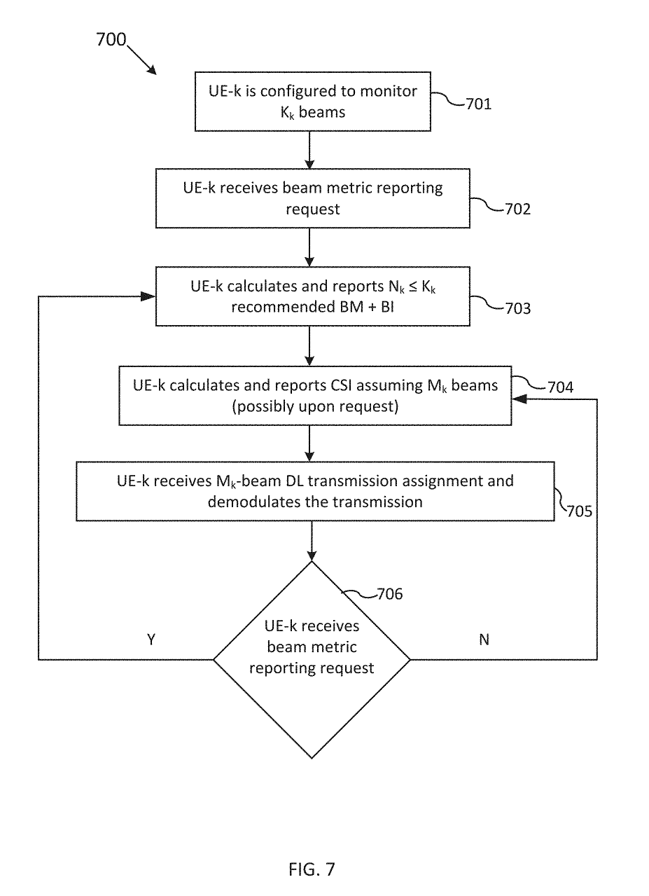

In one sub-embodiment, the UE is configured to report Nₖ≤Kₖ beam metrics (for example, either L1-RSRP or CSI) accompanied with a set of Nₖ BIs {BI(0), BI(1), . . . , BI(Nₖ−1)} wherein the n-th beam metric corresponds to BI(n). This embodiment can be illustrated in diagram 700 of FIG. 7 wherein UE-k is configured to monitor/measure Kₖ beams (step 701) where beam measurement is performed on the RS associated with the beams (such as CSI-RS). During the time when UE-k is connected to the network, UE-k receives beam metric (BM) reporting request from the network (step 702). If L1 DL control signaling is used, this request is analogous to aperiodic CSI reporting request/triggering. Here, the UE-k recommends to the network a subset of Nₖ beams to be used for DL data transmission to UE-k (step 703, analogous to CSI-RS ports in NR). The value of Nₖ can be chosen by UE-k (either reported separately or included in the beam metric report) or configured/assigned by the network (dynamically, signaled via L1/L2 DL control signaling), or both (UE reporting a subset to the network, and the network assigns the subset based on or in response to UE reporting). When the value of Nₖ is assigned by the network and signaled via L1 DL control signaling, it can be included in a DCI that requests/triggers UE-k to report aperiodic beam metric. Here the beam metrics are accompanied with the corresponding beam indices. Once the beam metric reporting is received by the network, the network can use this information to perform scheduling and link adaptation.

Subsequently, the UE is configured to measure the RS associated with the Mₖ beams followed by CSI calculation and reporting (step 704, via an UL channel). This reporting can be performed aperiodically (network requesting the report via L1 DL control channel) or periodically/semi-persistently. The CSI reporting is used for the network to perform slot-by-slot link adaptation and scheduling. If the CSI includes RI, PMI, and CQI, the network can perform a precoded DL transmission wherein a precoder is applied across the Mₖ beams to generate a desired number of layers (transmission rank). The CQI is calculated conditioned on RI and PMI (where a codebook can be used). This precoding performs selection and/or combination of the Mₖ beams for UE-k wherein the selection refers to selecting a subset of the Mₖ beams and the combination refers to applying a precoder (or weights) to the selected subset of the Mₖ beams if the selected subset comprises a plurality of beams. The number of beams Mₖ is functionally analogous to the number of CSI-RS ports for NR. The network can select this number Mₖ based on the value of Nₖ reported by the UE. This value Mₖ is dynamically signaled to UE-k via a DL channel—either together with the aperiodic CSI request (for aperiodic CSI reporting, included in the associated DCI) or separately from CSI reporting (multiplexed with some other signaling either in time- or frequency-domain). In some embodiments, the value Mₖ can also be selected by UE-k itself, or reported by the UE-k but assigned by the network based on or in response to UE reporting. When the UE is assigned/granted a DL transmission, the number of beams used for that particular DL transmission Mₖ (≤Kₖ) is signaled, either separately from or together with the DL assignment (step 705). The Mₖ beams in step 804 can be a subset of the Nₖ beams in step 703. In this case, the set of Mₖ beams can be configured to the UE using a

$$⌈ {log}_{2} ( \begin{matrix}{N}_{k} \\ {M}_{k}\end{matrix} ) ⌉$$

bits signaling or a size-Nₖ bitmap (via e.g. DCI). As a special case, the Mₖ beams in step 704 can be identical to the Nₖ beams in step 703.

Steps 704 and 705 can be repeated until the network requests UE-k to perform measurement and reporting of Nₖ≤Kₖ beam metrics (step 706). This is done, for instance, so that UE-k is assigned a good set of Nₖ beams for the purpose of DL channel measurement for DL transmission. When this beam metric reporting request is received by UE-k, step 703 is repeated, followed by 704 and 705.

As previously described, CSI can be used for beam metric (BM) in step 703. If this is the case, step 703 and 704 yield the same type of report especially if Mₖ is set to be equal to Nₖ. In this case, step 703 and 704 can be merged especially when UE-k is configured to report aperiodic CSI.

In another sub-embodiment, the UE is configured to report Kₖ beam metrics (for example, either L1-RSRP or CSI). Since all the Kₖ assigned beams are measured and their beam metrics reported, there is no need for reporting any beam index (BI). A basic procedure described in FIG. 7 is applicable with step 703 modified as follows: “UE-k calculates and reports Kₖ recommended BM (beam metrics).” As mentioned, there is no need for reporting any beam index (BI). With this scheme, step 702 comprises a request for reporting the beam metrics associated with all the Kₖ assigned beams. After receiving the report (which includes Kₖ beam metrics) from UE-k, the network can assign Mₖ out of Kₖ beams when UE-k is assigned a DL transmission just as described in the previous sub-embodiment.

In another sub-embodiment, the UE-k can be configured with either of the previously described sub-embodiments illustrated in FIG. 7. This switching can be signaled dynamically to UE-k either separately (for example, prior to the beam metric report request) or together with the beam metric report request.

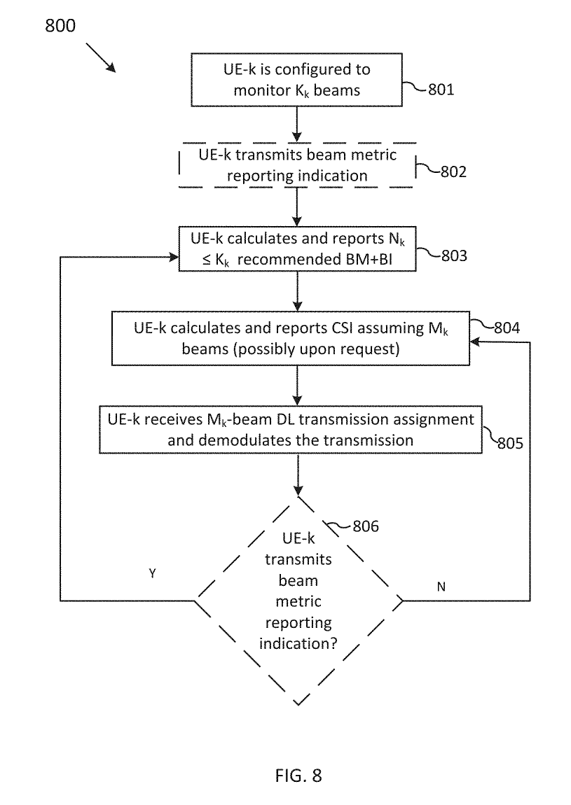

In another sub-embodiment, which can be combined with any of the previously described sub-embodiments illustrated in FIG. 7, steps 702 and 706 (which are network-initiated/configured) can be replaced by a UE-initiated beam metric reporting. In this case, UE-k does not receive any request (from the network) to report beam metric. Instead, UE-k (perhaps triggered by an event known to UE-k but not necessarily to the network) imitatively reports the beam metric (either Nₖ≤Kₖ beam metrics along with the associated beam indices, or all the Kₖ beam metrics) to the network. At least two possibilities are applicable. First, UE-k reports the beam metric via an UL channel (either PUCCH or PUSCH). This report can be a part of UL data transmission on PUSCH but includes a certain “type” indicator so that the network can distinguish this report from the rest of the UL data. Second, UE-k first sends a message to indicate that UE-k will report the beam metric via an UL channel. After this “report indication” or “report notification”, the beam metric report is transmitted. For instance, a fixed timing relationship between the “report indication” and the beam metric can be used. In some embodiments, the “report indication/notification” can include timing information which represents the offset (in OFDM symbols or slots or sub-frames) between the “report indication” and the beam metric report. In some embodiments, the beam metric report can be transmitted in a same slot/subframe as the “report indication/notification”. In some embodiments, the beam metric report can be transmitted by the UE without any “report indication/notification”. This sub-embodiment can be illustrated in FIG. 8 wherein step 801 comprises the wherein UE-k being configured to monitor Kₖ beams and steps 802 and 806 comprise UE-initiated procedures as UE-k itself initiates the beam metric reporting and transmits an associated “report indication” thereof. Upon decoding this report indication, the network knows the presence of beam reporting from UE-k.

As previously described, CSI can be used for beam metric (BM) in step 803. If this is the case, step 803 and 804 yield the same type of report especially if Mₖ is set to be equal to Nₖ. In this case, step 803 and 804 can be merged especially when UE-k is configured to report aperiodic CSI.

For embodiments 700 and 800 of FIGS. 7 and 8, respectively, the two steps (703/704 or 803/804) for the UE-k to down select the Kₖ beams from Nₖ to Mₖ can be used together (both are used) or separately (either one of the two is used).

For embodiments 700 and 800 of FIGS. 7 and 8, respectively, wherein the UE-k calculates and reports CSI assuming the Mₖ beams (step 704 or 804), as previously described the UE can select the value of Mₖ (with optionally including subset selection of size Mₖ). The value of Mₖ and, optionally, the subset can be signaled as a part of CSI (together with, for instance, CQI, PMI, and/or RI). Since this reporting can be initiated by the UE-k without any request from the network/gNB, some provisioning for the UL channel resource is required.

In one example, the UE-k can be configured (e.g. via RRC signaling or L2 control signaling) some PUCCH (physical uplink control channel) resources for “grant-free” (configured grant) UL transmission. This “grant-free” configuration can include resource allocation, periodicity, and PUCCH format. Power control related configuration can come from PUCCH configuration.

In another example, the UE-k can be configured (e.g. via RRC signaling or L2 control signaling) some PUSCH (physical uplink data channel) resources for “grant-free” (configured grant) UL transmission. This is more suitable for “grant-free” aperiodic CSI reporting (wherein an UL grant that includes a CSI request is absent). This “grant-free” configuration can include resource allocation (for instance, a set of subframes/slots/symbols and/or RB allocation).

Since the parameter Mₖ (and, optionally, the subset selection of Mₖ beams) is also used for DL transmission (step 705 or 805), it will require a more reliable error protection than CSI parameters. This can be achieved, for instance, by adding CRC on the UCI which, in Rel.15/16 NR, is possible with some larger PUCCH formats and PUSCH. Some extra protection is however needed, for instance, to resolve collisions and/or missed/incorrect reports by the network/gNB.

To resolve collisions or missed/incorrect reports by the network/gNB, HARQ-ACK for PUCCH and/or PUSCH can be used. Optionally, the UE can expect to receive some signaling on MAC CE in the next PDSCH scheduling. In addition, the UE can be assigned one default CORESET, such as CORESET 0, unaffected from the reported beams. This is because if the beam for CORESET 0 changes, the UE would need to resynchronize.

This can also apply to step 702/703 or 802/803 where the UE-k selects the value of Nₖ along with the size-Nₖ subset.

When DL-UL reciprocity is applicable, some variations of the above embodiments are possible. In one variation, CSI reporting (for example, step 704 or 804) can include CQI and RI, but without PMI. To enable this variation, UE-k can be configured to transmit SRS for UL transmit beams that are reciprocal to the Mₖ assigned DL beams. This can be done with or without CSI-RS. If each of the Mₖ assigned DL beams is associated with one SRS and one CSI-RS, UE-k can use both CSI-RS and SRS (via DL-UL channel reciprocity) for CSI calculation. In another variation, beam metric calculation (for example, step 703 or 803) can also use either SRS, or both CSI-RS and SRS, if UE-k is configured to transmit SRS for UL transmit beams that are reciprocal to the Mₖ assigned DL beams.

For the third component (that is, UL MIMO configuration), to maintain seamless mobility and boundary-less network, any control signaling required for configuration can be performed dynamically, either with L1 DL control signaling (via, e.g. PDCCH in NR) or L2 DL control signaling (via, e.g. MAC CE in NR). Reconfiguration via higher-layer (L3/RRC) signaling is either minimized or avoided.

Several embodiments that are suited for beam-based access (wherein conventional cell boundaries are no longer utilized) are given below. The design below can be characterized as “flat” (as opposed to hierarchical).

One radio resource unit can be defined in terms of one spatial unit (termed “beam” for illustrative purposes) and one time-frequency unit (for example, symbol-sub-carrier, slot-sub-carrier, slot-frequency resource block, etc.).

In another embodiment, a method for configuring UL MIMO can be described as follows. In this case, “beam” can be analogous to the conventional UL (SRS) antenna port in terms of its function for MIMO-related transmission and measurement. Each beam can be associated with an SRS which can span over one or multiple time-frequency units. These Kₖ UL beams are formed at the UE. When the UE (labeled UE-k) transmits the SRS for each of the beams to the network. In turn, the network can perform scheduling and link adaptation to assign an UL transmission to UE-k via at least one of the Kₖ beam(s) wherein some precoding for data transmission can be performed across the assigned beam(s). The beam selection (Mₖ out of Kₖ beams) can be changed dynamically by the UE. Here, dynamic refers to the use of physical layer (L1) control signaling or at most MAC layer (L2) control signaling to effect the change in beam assignment. In addition, dynamic is to be contrasted with semi-static (wherein higher-layer/RRC/L3 signaling is used which can cause disruption in seamless access due to its associated latency) or static (unchanged). Likewise, the value of Kₖ with which UE-k is configured can be signaled to UE-k (by the network) via L1 or L2 DL control signaling (for NR, it is PDCCH or MAC CE). When UE-k enters the network, an initial/default value of Kₖ can be configured via higher-layer signaling. The beams are strictly UE-specific.

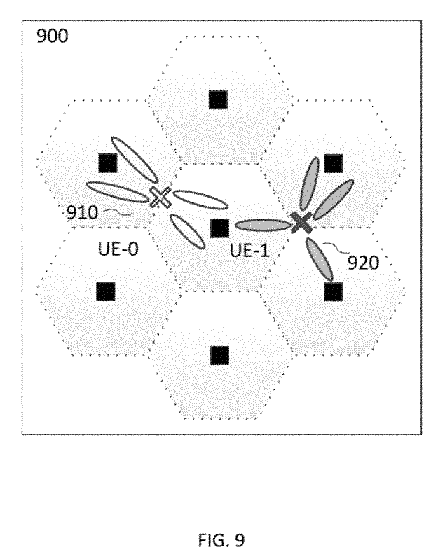

This embodiment can be illustrated in FIG. 9. In diagram 900, each of the two UEs (UE-0 and UE-1) forms Kₖ=4 beams (910 for UE-0 and 920 for UE-1) wherein each of these beams is associated with an SRS transmission. Since the beams are formed at the UE side, the two 4-beam sets may not overlap. As UE-k (k=0 or 1) moves, the beam selection (which can include the set of beams and/or the number of beams in the assigned set) can change.

As mentioned, the change of Kₖ can be signaled to UE-k via L1 or L2 DL control signaling (for NR, it is PDCCH or MAC CE). If L1 control signaling is used, the number of beams (Kₖ) beam assignment signaling can be included in a UE-specific downlink control information (DCI) or a UE-group DCI—masked or identified with a UE identification (such as C-RNTI) or a special group RNTI, respectively. The value of Kₖ can be configured/assigned by the network (dynamically, signaled via L1/L2 DL control signaling).

To illustrate further, each of the UEs in diagram 900 forms the 4 UL beams by measuring 4 SRS associated with those 4 beams. The set of 4 SRSs is then used by the network to measure the UL channel for the purpose of link adaptation and scheduling. As UE-k moves, the beams (formed via precoding) can change. But since the UE forms those beams, there is no need for any additional DL control signaling. In other words, the formation of those beams is transparent to the network.

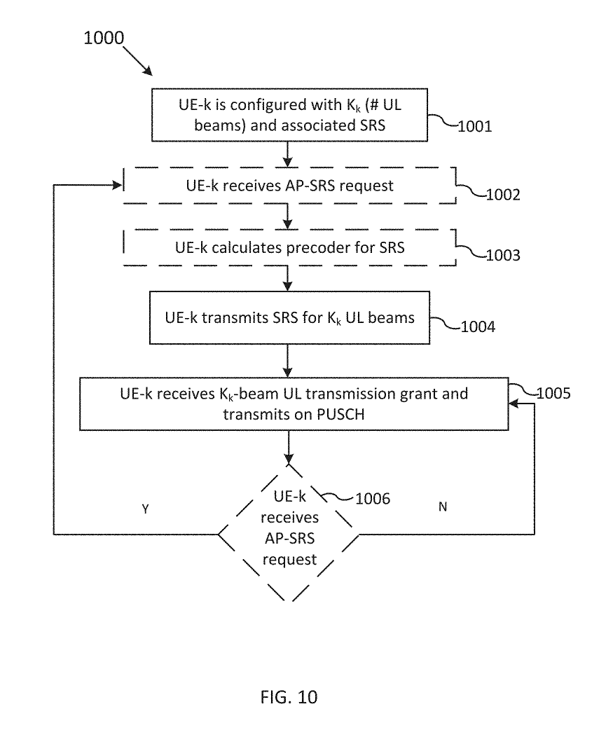

In one sub-embodiment, the UE is configured with Kₖ UL beams along with Kₖ SRS resources (or simply assignments) wherein the n-th UL beam corresponds to the n-th SRS resource (or simply assignment). This embodiment can be illustrated in diagram 1000 of FIG. 10 wherein UE-k is configured with Kₖ UL beams and their associated SRS resources (or simply assignments—step 1001). During the time when UE-k is connected to the network, UE-k can receive aperiodic SRS (AP-SRS) request from the network (step 1002). Note that UE-k can also be configured with periodic SRS (P-SRS). If UE-k is configured with semi-persistent SRS (SP-SRS), in that case, SRS request is not applicable. But when an AP-SRS request is used, L1 DL control signaling (wherein the AP-SRS trigger/request is included in a DCI) can be utilized. If precoding is to be applied to form each of the UE-k SRS, UE-k can calculate the precoder for each of this SRS (step 1003).

Subsequently, UE-k transmits the SRS for each of the Kₖ beams (step 1004). When UE-k receives an UL transmission grant on the Kₖ beams, the UE can transmit its UL data on PUSCH (or an UL channel functionally analogous to PUSCH—step 1005). The DCI associated with the UL transmission grant can include transmit PMI (TPMI) and/or transmit RI (TRI) associated with the Kₖ-beam transmission (analogous to Kₖ beams—port transmission in NR). Optionally, UL beam selection can be performed via SRS resource/assignment indication (termed the SRI for illustrative purposes) that selects Nₖ out of Kₖ beams. This SRI can be accompanied with TPMI and/or TRI—associated with Nₖ beams.

Steps 1004 and 1005 can be repeated until the network requests UE-k to transmit aperiodic SRS (when UE-k is configured with aperiodic SRS—step 1006). If UE-k is configured with periodic SRS, steps 1004 and 1005 can simply be repeated. If UE-k is configured with semi-persistent SRS, steps 1004 and 1005 can be repeated until UE-k receives a deactivation command.

When DL-UL reciprocity is applicable, some variations of the above embodiments are possible. In one variation, the associated UL grant in step 1005 can include TRI and SRI, but without PMI. To enable this variation, UE-k can be configured to receive CSI-RS that are reciprocal to the Kₖ assigned UL beams. This can be done in conjunction with SRS. If each of the Kₖ assigned UL beams is associated with one SRS and one CSI-RS, UE-k can use both CSI-RS and SRS (via DL-UL channel reciprocity) for SRS precoder calculation. Therefore, UE-k receives the CSI-RS transmitted either in the same scheduling time unit or after the AP-SRS request (between step 1002 and 1003). If TPMI is not included in the UL grant, Mₖ-layer transmission can be performed using SRI by selecting Mₖ out of Kₖ UL beams (wherein each of the beams is analogous to one layer).

For the fourth component (that is, DL control signaling), a method for enabling reception of DL MIMO transmission is described below.

When UE-k is assigned Mₖ beams (selected out of the Kₖ beams the UE monitors) for DL transmission, MIMO-related operations such as precoding, rank adaptation, and spatial multiplexing can be performed across the Mₖ beams just as those operations can be performed across Mₖ antenna ports.

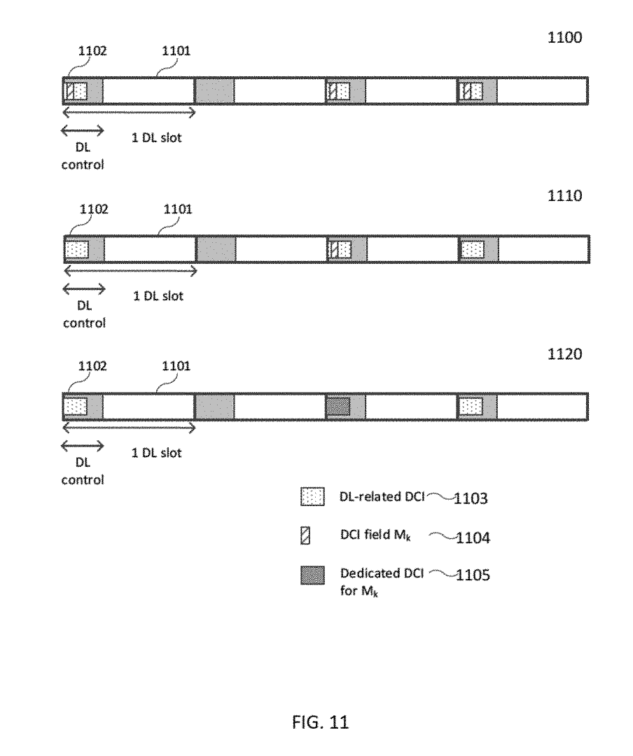

Since the value of Mₖ is signaled via L1 or L2 DL control signaling, it can be changed dynamically. This can be signaled either via a separate/dedicated L1/L2 signaling or a DL-related DCI as a part of the DL assignment. FIG. 11 illustrates several example embodiments for this operation wherein DL slot represents one DL scheduling time unit. In each DL slot (component 1101), some resources are used for DL control transmission (component 1102). In this example, DL control is multiplexed in time-domain with data. Other multiplexing schemes such as frequency, time-frequency, and/or spatial multiplexing (between control and data) can also be used. In diagram 1100, every DL-related DCI (component 1103) includes a DCI field for indicating the value of Mₖ (component 1104).

In some embodiments, in diagram 1110, not every DL-related DCI (component 1103) includes a DCI field for indicating the value of Mₖ. That is, a DCI field for indicating the value of Mₖ (component 1104) is included in the DL-related DCI only when the value of Mₖ needs to be updated. Several possibilities can be conceived. In a first possibility, the payload of the DL-related DCI (1103) is kept the same regardless whether the DCI field 1104 is included in 1103 or not. In this case, the indicator for Mₖ uses an existing DCI field and a flag/indicator can be added to differentiate the indication of Mₖ from another use. In a second possibility, the payload of the DL-related DCI (1103) increases when the DCI field 1104 is included in 1103. In this case, the UE may be required to increase the number of possible DCI formats/payloads upon detection.

In some embodiments, in diagram 1120, a dedicated DCI format for indicating the value of Mₖ (1105, not a part of DL-related DCI) is used. Several possibilities can be conceived. In a first possibility, a UE-group DCI is used for this purpose. In this case, the DCI can include the value(s) of Mₖ for a group of UEs wherein a group includes at least one UE. This DCI can be masked with a group RNTI. This DCI can either include one value of Mₖ shared by a group of UEs, or several Mₖ values wherein each value is associated with one UE. This DCI can be received either periodically or aperiodically. A variation of this possibility can be devised when the dedicated DCI (signaled on L1 DL control signaling) is replaced with MAC CE (via L2 control signaling). In a second possibility, prior to receiving this dedicated DCI, the UE (or the group of UEs) receives a paging message (via L1 or L2 DL control signaling) that indicates a change in the value of Mₖ for the UE (or the group of UEs). In this sense, the dedicated DCI is received aperiodically. A variation of this possibility can be devised when the dedicated DCI (signaled on L1 DL control signaling) is replaced with MAC CE (via L2 control signaling).

When UE-k is assigned to perform DL transmission over Mₖ DL beams, the UE can be configured to report CSI for Mₖ beams. This is functionally analogous to Mₖ ports (for NR). For example, for each of the possible RI values, the UE can be configured with an Mₖ-port codebook for PMI calculation. Here, precoding comprises either beam selection or beam combination.

Any of the various embodiments can be utilized independently or in combination with at least one other embodiment.

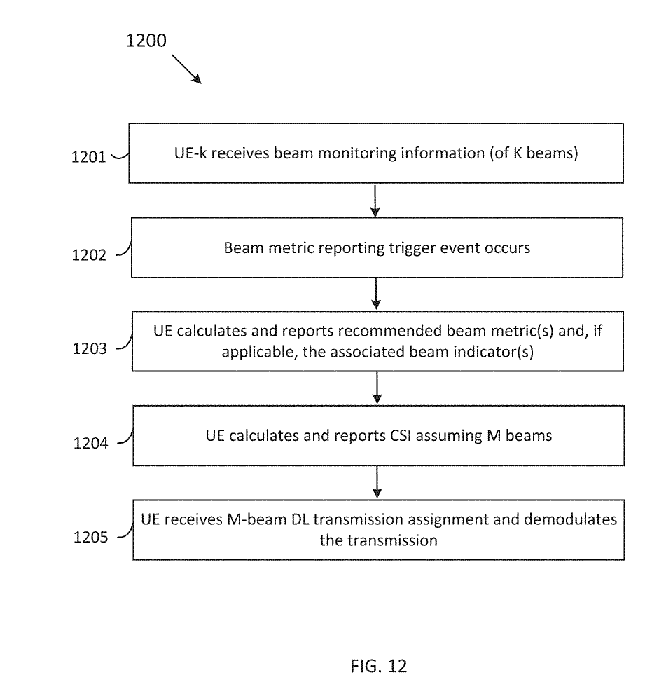

FIG. 12 illustrates a flowchart for an example method 1200 wherein a UE receives and decodes CSI reporting configuration information according to an embodiment of the present disclosure. For example, the method 1200 can be performed by the UE 116.

The method 1200 begins with the UE receiving, from a base station, and decoding beam monitoring information (step 1201). The beam monitoring information includes a request for the UE to monitor and measure quality of K beams. The quality is represented with a beam metric, such as RS received power (RSRP), CQI, or signal-to-interference-plus-noise-ratio (SINR). The request can be signaled via higher-layer (RRC) signaling, L2 control channel (MAC CE), or L1 control channel (via PDCCH). As the UE monitors the K beams, beam metric reporting can be triggered (step 1202). The triggering event can either be initiated by the network (transmitted by the BS) or by the UE itself. If initiated by the network, a beam metric request can be signaled via L1 (DCI-based, either DL- or UL-related DCI) or L2 (MAC CE based) DL control channel. If initiated by the UE, the UE can transmit a notification message (that the UE is about to transmit the beam metric report in a current or future slot/subframe/transmission time unit), a report request (that the UE requests the network/base station to trigger the beam metric report), or the beam metric report (without any notification or report request). Subsequently, the UE calculates and reports at least one beam metric report associated with at least one recommended beam (step 1203). The beam metric report can also be accompanied with the associated beam indicator(s), if applicable.

Subsequently, the UE calculates and reports CSI assuming a transmission hypothesis of M beams (step 1204) where M can be either signaled by the network/BS (for instance, as a part of CSI request or CSI reporting configuration) or determined by the UE (for instance, as a part of CSI report), and reported on a pre-configured uplink channel resource. From UE perspective, the beam metric report can be updated at a slower rate than the CSI report because beam metric report can be used by the network/BS to assign DL transmission ports to the UE. Subsequently, the UE can receive an M-beam DL transmission assignment (for instance, via a DL-related DCI transmitted on the L1 DL control channel such as PDCCH) and the associated DL transmission, which the UE demodulates (step 1205).

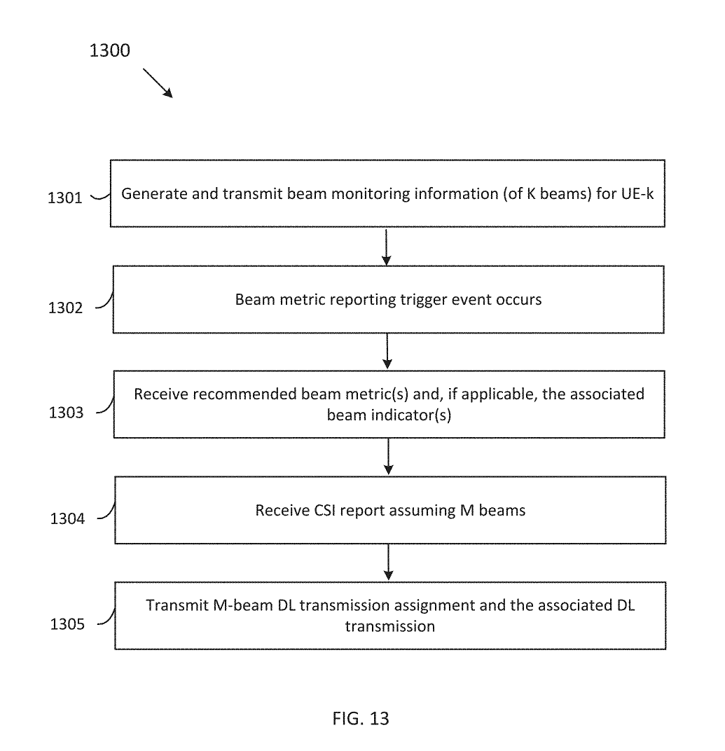

FIG. 13 illustrates a flowchart for an example method 1300 wherein a BS generates beam monitoring information for a UE (labeled as UE-k) according to an embodiment of the present disclosure. For example, the method 1300 can be performed by the BS 102.

The method 1300 begins with the BS generating and transmitting beam monitoring information for a UE, labelled UE-k (step 1301). The beam monitoring information includes a request for UE-k to monitor and measure quality of K beams. The quality is represented with a beam metric, such as RS received power (RSRP), CQI, or signal-to-interference-plus-noise-ratio (SINR). The request can be signaled via higher-layer (RRC) signaling, L2 control channel (MAC CE), or L1 control channel (via PDCCH). As UE-k monitors the K beams, beam metric reporting can be triggered (step 1302). The triggering event can either be initiated by the network (transmitted by the base station) or by the UE itself. If initiated by the network, a beam metric request can be signaled via L1 (DCI-based, either DL- or UL-related DCI) or L2 (MAC CE based) DL control channel. If initiated by the UE, UE-k can transmit a notification message (that UE-k is about to transmit the beam metric report in a current or future slot/subframe/transmission time unit), a report request (that UE-k requests the network/base station to trigger the beam metric report), or the beam metric report (without any notification or report request). Subsequently, the BS receives at least one beam metric report associated with at least one recommended beam (step 1303). The beam metric report can also be accompanied with the associated beam indicator(s), if applicable.

Subsequently, the BS receives the CSI report assuming a transmission hypothesis of M beams (step 1304) where M can be either signaled by the network/BS (for instance, as a part of CSI request or CSI reporting configuration) or determined by the UE (for instance, as a part of CSI report), and reported on a pre-configured uplink channel resource. The beam metric report can be reported and received at a slower rate than the CSI report because beam metric report can be used by the network/BS to assign DL transmission ports to the UE. Subsequently, the BS can transmit an M-beam DL transmission assignment (for instance, via a DL-related DCI transmitted on the L1 DL control channel such as PDCCH) and the associated DL transmission (step 1305).

Although FIGS. 12 and 13 illustrate examples of methods for receiving configuration information and configuring a UE, respectively, various changes can be made to FIGS. 12 and 13. For example, while shown as a series of steps, various steps in each figure can overlap, occur in parallel, occur in a different order, occur multiple times, or not be performed in one or more embodiments.

Although the present disclosure has been described with an example embodiment, various changes and modifications can be suggested by or to one skilled in the art. It is intended that the present disclosure encompass such changes and modifications as fall within the scope of the appended claims.

What is claimed:

1. A user equipment (UE) comprising:
a transceiver configured to receive, from a base station (BS), beam monitoring information, a downlink (DL) transmission assignment, and an associated DL transmission, wherein the beam monitoring information includes a request for the UE to monitor and measure a quality of K beams; and
a processor operably connected to the transceiver, the processor configured to decode the beam monitoring information, the DL transmission assignment, and the associated DL transmission,
wherein the transceiver is further configured to transmit, to the BS, a beam metric report and a channel state information (CSI) report.

2. The UE of claim 1, wherein:
the processor is configured to:
measure the quality of the K beams; and
select N of the K beams to include in the beam metric report based on the measured quality,
the beam metric report indicates a quality of the N beams, and
N is less than or equal to K.

3. The UE of claim 2, wherein:
the processor is configured to:
select M beams based on N; and
generate the CSI report based on a transmission hypothesis on the M beams that the UE assumes the BS will use for the associated downlink transmission, and
the transceiver is configured to report a selected value for M on a pre-configured uplink channel resource.

4. The UE of claim 2, wherein:
the transceiver is configured to receive an indication of M beams for the CSI report from the BS, and
the processor is configured to generate the CSI report based on a transmission hypothesis on M beams that the UE assumes the BS will use for the associated downlink transmission

5. The UE of claim 1, wherein the transceiver is configured to:
receive, from the BS, a request for the beam metric report; and
transmit the beam metric report in response to the request from the BS.

6. The UE of claim 1, wherein the beam metric report is initiated by the UE.

7. The UE of claim 1, wherein the transceiver is configured to transmit the beam metric report with at least one beam indicator of one of the K beams for which the quality thereof is reported in the beam metric report.

8. A base station (BS) comprising:
a processor configured to generate beam monitoring information, a downlink (DL) transmission assignment, and an associated DL transmission, wherein the beam monitoring information includes a request for a user equipment (UE) to monitor and measure a quality of K beams; and
a transceiver operably connected to the processor, the transceiver configured to:
transmit, to the UE, the beam monitoring information, the DL transmission assignment, and the associated DL transmission; and
receive, from the UE, a beam metric report and a channel state information (CSI) report.

9. The BS of claim 8, wherein:
the beam metric report includes indicates a quality of N beams selected by the UE for reporting, and
N is less than or equal to K.

10. The BS of claim 8, wherein the CSI report is associated with a transmission hypothesis on M beams that the UE assumes the BS will use for the associated downlink transmission.

11. The BS of claim 8, wherein the transceiver is configured to:
transmit, to the UE, a request for the beam metric report; and
receive the beam metric report in response to the request to the UE.

12. The BS of claim 8, wherein the beam metric report is initiated by the UE.

13. The BS of claim 8, wherein the transceiver is configured to receive the beam metric report with at least one beam indicator.

14. A method for operating a user equipment (UE), the method comprising:
receiving, from a base station (BS), beam monitoring information, a downlink (DL) transmission assignment, and an associated DL transmission, wherein the beam monitoring information includes a request for the UE to monitor and measure a quality of K beams;
decoding the beam monitoring information, the DL transmission assignment, and the associated DL transmission; and
transmitting, to the BS, a beam metric report and a channel state information (CSI) report.

15. The method of claim 14, further comprising:
measuring the quality of the K beams; and
selecting N of the K beams to include in the beam metric report based on the measured quality,
wherein the beam metric report includes indicates a quality of the N beams, and
wherein N is less than or equal to K.

16. The method of claim 15, further comprising:
selecting M beams based on N;
generating the CSI report based on a transmission hypothesis on the M beams that the UE assumes the BS will use for the associated downlink transmission; and
reporting a selected value for M on a pre-configured uplink channel resource.

17. The method of claim 15, further comprising:
receiving a value for M beams for the CSI report from the BS; and
generating the CSI report based on a transmission hypothesis on M beams that the UE assumes the BS will use for the associated downlink transmission.

18. The method of claim 14, further comprising:
receiving, from the BS, a request for the beam metric report,
wherein transmitting the beam metric report comprises transmitting the beam metric report in response to the request from the base station.

19. The method of claim 14, wherein the beam metric report is initiated by the UE.

20. The method of claim 14, wherein transmitting the beam metric report comprises transmitting the beam metric report with at least one beam indicator.
